(19) United States
(12) Patent Application Publication
(10) Pub. No.: US 2025/0385464 A1
(43) Pub. Date: Dec. 18, 2025

(54) ELECTRICAL CONNECTOR AND ASSEMBLY HAVING THE SAME

(71) Applicant: FOXCONN INTERCONNECT TECHNOLOGY LIMITED, Grand Cayman (KY)

(72) Inventors: Ming-Xiang Chen, New Taipei (TW); Kuo-Chun Hsu, New Taipei (TW)

(21) Appl. No.: 19/234,903

(22) Filed: Jun. 11, 2025

(30) Foreign Application Priority Data
Jun. 13, 2024 (CN) 202410766342.8

(51) Int. Cl. H01R 13/533; H01R 12/72; H01R 13/717

(52) U.S. Cl. CPC H01R 13/533; H01R 12/721; H01R 13/7175

(57) ABSTRACT

An electrical connector assembly includes an electrical connector and a heat dissipation module. The electrical connector includes an insulating housing and plural terminals fixed to the insulating housing. The insulating housing has a card slot. The terminals extend into the card slot. The electrical connector has a support face. One end of the heat dissipation module is arranged on the support face of the electrical connector. The electrical connector has an additional terminal exposed at the support face. The heat dissipation module comprises an additional-function module and an interface port connected to the additional-function module. One end of the heat dissipation module is disposed on the support face so that the interface port contacts the additional terminal and a working circuit of the additional-function module is connected, allowing the heat dissipation module to have additional functions and be easy to operate.

### BACKGROUND OF THE INVENTION

### Field of the Invention

The present disclosure relates generally to an electrical connector and an assembly thereof, and particularly to an electrical connector which can be assembled with a heat dissipation module having additional features, and an assembly having the same.

### Description of Related Arts

Chinese Patent CN217036088U discloses a card edge connector and a heat dissipation module assembled to the card edge connector. The card edge connector includes an insulating housing and conductive terminals. The insulating housing is formed with a card slot passing through the front. The conductive terminal includes a contacting portion extending into the card slot. The contacting portion is mechanically connected to an electronic card inserted into the card slot. The heat dissipation module is arranged at a top portion of the card edge connector and contacts the electronic card for dissipating heat. A fixing structure for assembly is arranged between the heat dissipation module and the card edge connector. However, quickly ensuring stability of assembly between the heat dissipation module and the card edge connector, and the functionality of adding heat dissipation modules as needed, are problems which need to be solved. U.S. Pat. No. 10,566,717 discloses a card edge connector, a heat dissipation module, and an electrical card. The electrical card is inserted into the card edge connector. The heat dissipation module and the electrical card are mounted on the same side of the card edge connector. The card edge connector includes an insulative housing, a plurality of terminals retained in the insulative housing, a nut retained in the insulative housing, and a shell covering the insulative housing. The insulative housing defines a slot going through the front surface thereof. The electrical card is inserted into the slot to establish an elastic connection with the terminals. The shell is made of a metal sheet and includes a top wall. The top wall defines a through hole aligning with the nut. The heat dissipation module has an ear portion located above the top wall, and the ear portion defines a mounting hole aligned with the through hole. A bolt is fixed to the nut through the mounting hole and the through hole. Similar to the above patent, a fixing structure for assembly is arranged between the heat dissipation module and the card edge connector. However, quickly ensuring stability of assembly between the heat dissipation module and the card edge connector, and the functionality of adding heat dissipation modules as needed, are problems which need to be solved.

Therefore, providing an improved electrical connector and an assembly having the same for solving the above problems is desired.

### SUMMARY OF THE INVENTION

An object of the present disclosure is to provide an electrical connector with additional terminals to come to contact with an additional-function module on a heat dissipation module.

To achieve the above-mentioned object, the present disclosure provides the following technical solutions. An electrical connector assembly includes an electrical connector, at least one additional-terminal, and a heat dissipation module. The electrical connector includes an insulating housing having a card slot, a support face positioned above the card slot, and a plurality of terminals fixed to the insulating housing and extending into the card slot. The at least one additional terminal is exposed at the support face. The heat dissipation module includes an additional-function module, and an interface port electrically connected to the additional-function module. The interface port contacts the at least one additional terminal to kick off a working circuit of the additional-function module when one end of the heat dissipation module is disposed on the support face.

Furthermore, the heat dissipation module includes a heat dissipation board and a connection module. The heat dissipation board includes a top surface and a bottom surface opposite each other. One end of the bottom surface has a stage portion recessed upward. The connection module is assembled at the stage portion. The top surface has an installation slot recessed downward, and the additional-function module is accommodated in the installation slot.

Furthermore, the connection module includes a main body, the interface port fixed at the main body, and a cable unit connected to the interface port. The heat dissipation board has a connection slot in fluid communication with the stage portion and the installation slot. The cable unit passes through the connection slot, enters the installation slot, and is connected to the additional-function module.

Furthermore, the cable unit and the interface port are connected through a surface mounting technology or a through-hole mounting technology.

Furthermore, the heat dissipation module includes a nameplate and a cover covering the top surface of the heat dissipation board.

Furthermore, the heat dissipation module comprises an abutting face arranged at the support face. The interface port is exposed at the abutting face. The electrical connector includes a fixing member protruding from the support face. The abutting face has a corresponding notch engaging the fixing member to assemble the heat dissipation module to the electrical connector.

Furthermore, the additional-function module is an LED module, and the LED module comprises an LED light for emitting a combination of red, green, and blue lights.

An electrical connector adapted for being inserted with a card module and being assembled with a heat dissipation module includes an insulating housing, a support face, a plurality of terminals, and at least one additional terminal. The insulating housing has a card slot. The support face is positioned above the card slot. The terminals extend into the card slot. The at least one additional terminal is exposed at the support face and is configured to electrically connect with an additional-function module on the heat dissipation module when the heat dissipation module is disposed on the support face.

Furthermore, the electrical connector further comprising a protrusion portion formed on the insulating housing and a metal shell surrounding the insulating housing. The insulating housing has a front face and a rear face opposite each other and a top face and a bottom face positioned between the front face and the rear face. The card slot passes through the front face. The protrusion portion is formed on the top face and has an additional-terminal slot. The at least one additional terminal includes an additional contacting portion arranged at the additional-terminal slot. The metal shell includes a top plate covering the top face of the insulating housing. The support face is formed at the top plate. The top plate has an opening corresponding to the protrusion portion. The additional contacting portion is exposed at the support face.

Furthermore, the insulating housing includes a key in front of the card slot and the at least one additional terminal is located behind the key.

Furthermore, the additional contacting portion is a portion bent downward of the additional terminal.

Furthermore, the at least one additional terminal comprises an additional contacting portion protruding out of the support face.

Furthermore, starting from one end of the at least one additional terminal, the additional terminal extends upwards, bends and extends towards the front face, bends and extends upwards until protruding out of the support face, bends downward to form the additional contacting portion, and extends below the support face.

Furthermore, a side of the additional contacting portion distal from the front face slopes down at a steeper angle than a side of the additional contacting portion proximal to the front face.

A heat dissipation module for dissipating heat from a card module and for mating with an electrical connector includes a heat dissipation board having an installation slot, an additional-function module arranged in the installation slot, and a connection module having a main body, an interface port, and a cable unit. The main body of the connection module is attached to one end of the heat dissipation board and has an abutting face facing away from the heat dissipation board. The interface port is embedded in the main body and partially exposed at the abutting face of the main body. The cable unit of the connection module is connected to the interface port and the additional-function module.

Furthermore, the main body of the connection module is formed with a notch for engaging a fixing member of the electrical connector.

Furthermore, the interface port comprises an interface-contacting portion exposed at and substantially coplanar with the abutting face of the main body.

Furthermore, the heat dissipation board has a top surface and an opposite bottom surface configured to contact and dissipate heat from the card module.

Furthermore, the heat dissipation module further includes a nameplate and a cover covering the top surface.

Furthermore, the additional-function module is an LED module, and the LED module comprises an LED light

Compared to conventional techniques, by arranging an additional terminal on an electrical connector for connecting to an additional-function module arranged at the heat dissipation module, the present disclosure connects a working circuit of the additional-function module after assembling the heat dissipation module and the electrical connector, achieving integration of multiple functions for the heat dissipation module.

Other advantages and novel features of the disclosure will become more apparent from the following detailed description of the present embodiment when taken in conjunction with the accompanying drawings.

### BRIEF DESCRIPTION OF THE DRAWING

FIG. 1 is a perspective view of an electrical connector assembly according to a first embodiment of the present disclosure, wherein an electronic card is inserted into an electrical connector;

FIG. 2 is another perspective view of FIG. 1;

FIG. 3 is an exploded perspective view of a portion of FIG. 1, wherein portions of a heat dissipation module and the electronic card are omitted;

FIG. 4 is another perspective view of FIG. 3;

FIG. 5 is an exploded perspective view of a portion of the heat dissipation module of FIG. 2;

FIG. 6 is another perspective view of FIG. 5;

FIG. 7 is a perspective view of the electrical connector in FIG. 1;

FIG. 8 is an exploded perspective view of FIG. 7;

FIG. 9 is a further exploded perspective view of FIG. 8 from another perspective;

FIG. 10 is a cross-sectional view taken along line A-A of FIG. 1, wherein an encircled portion is enlarged;

FIG. 11 is a perspective view of an electrical connector assembly according to a second embodiment of the present disclosure, wherein an electronic card is inserted into an electrical connector;

FIG. 12 is another perspective view of FIG. 11;

FIG. 13 is a partially exploded perspective view of a portion of FIG. 11, wherein portions of a heat dissipation module and the electronic card are omitted;

FIG. 14 is another perspective view of FIG. 13;

FIG. 15 is an exploded perspective view of a portion of the heat dissipation module according to the second embodiment of the present disclosure;

FIG. 16 is another exploded perspective view of FIG. 15;

FIG. 17 is a cross-sectional view taken along line B-B of FIG. 11, wherein a portion of the heat dissipation module and the electronic card is omitted; and

FIG. 18 is a cross-sectional view taken along line C-C of FIG. 11, wherein a portion of the heat dissipation module and the electronic card is omitted.

### DETAILED DESCRIPTION OF THE PREFERRED EMBODIMENT

Reference will now be made to the figures to describe the preferred embodiments of the present disclosure in detail.

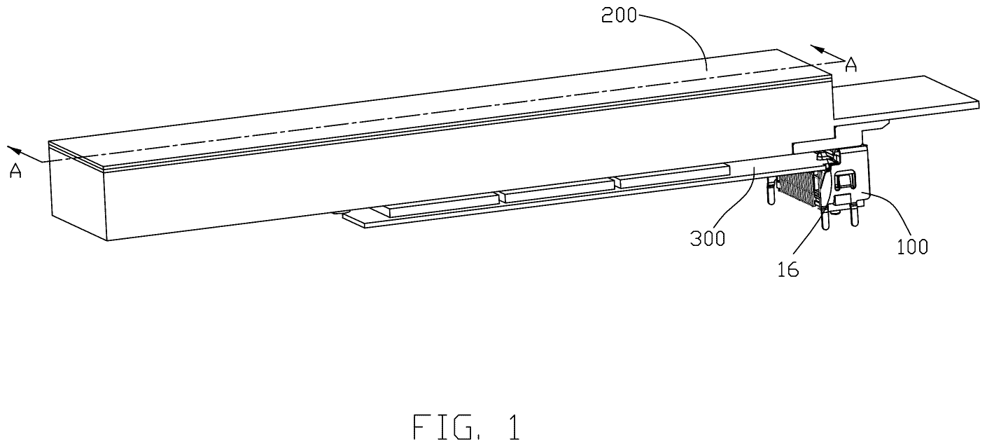

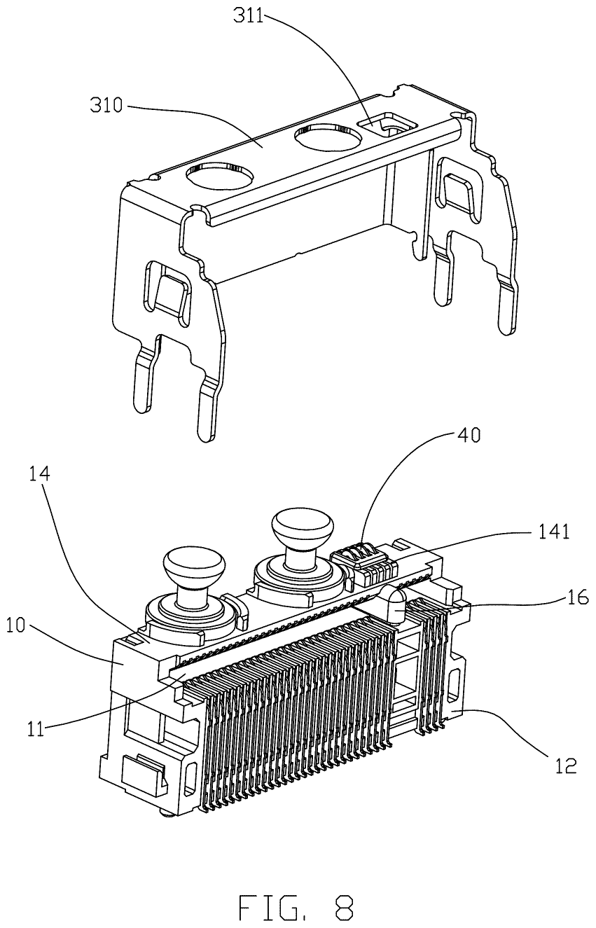

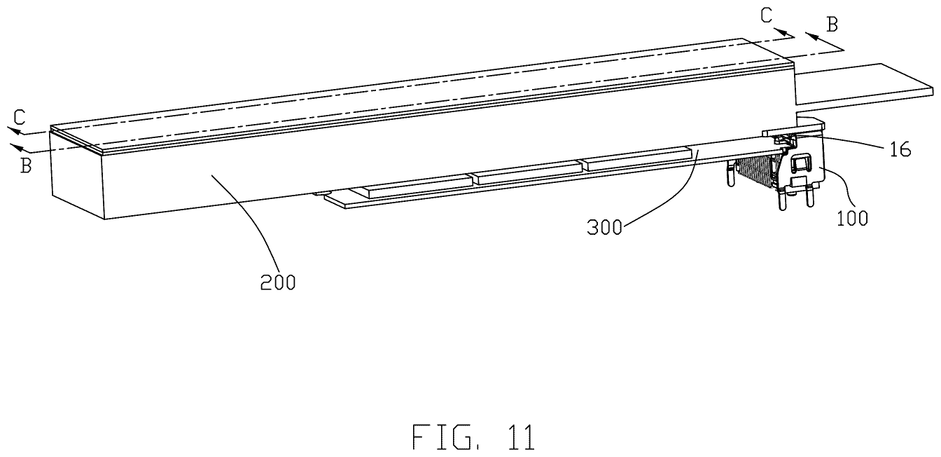

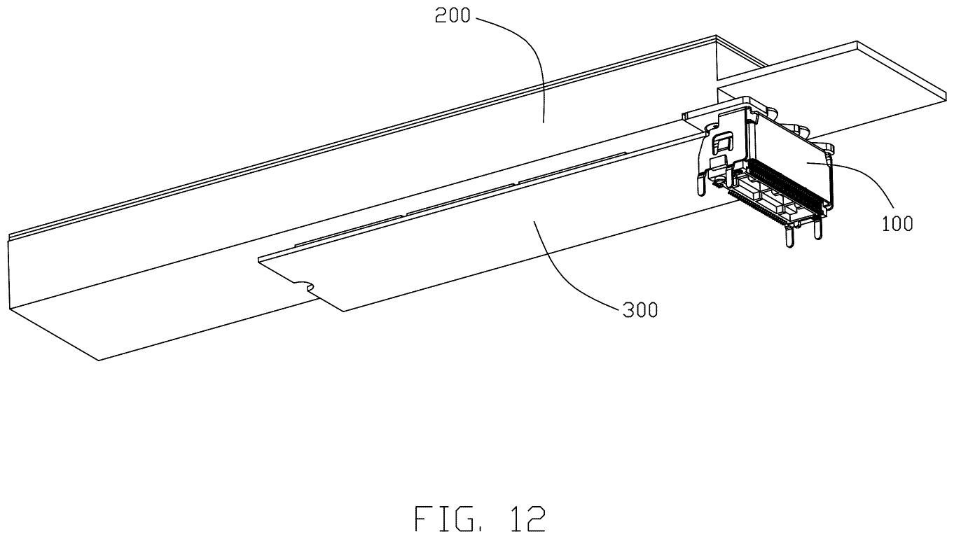

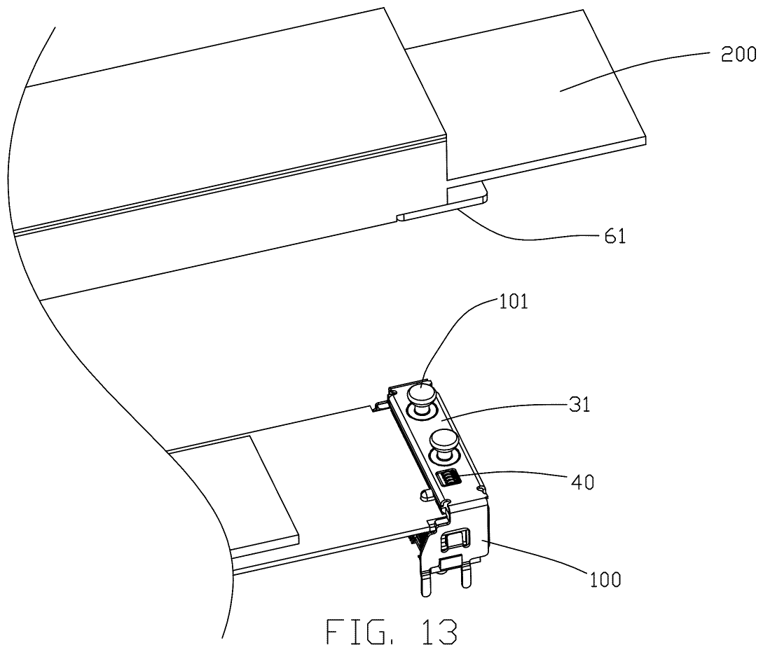

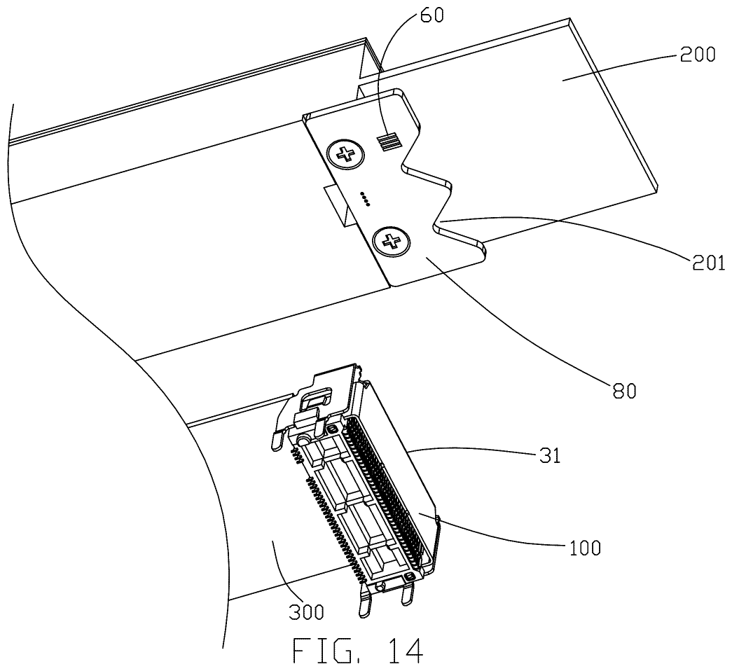

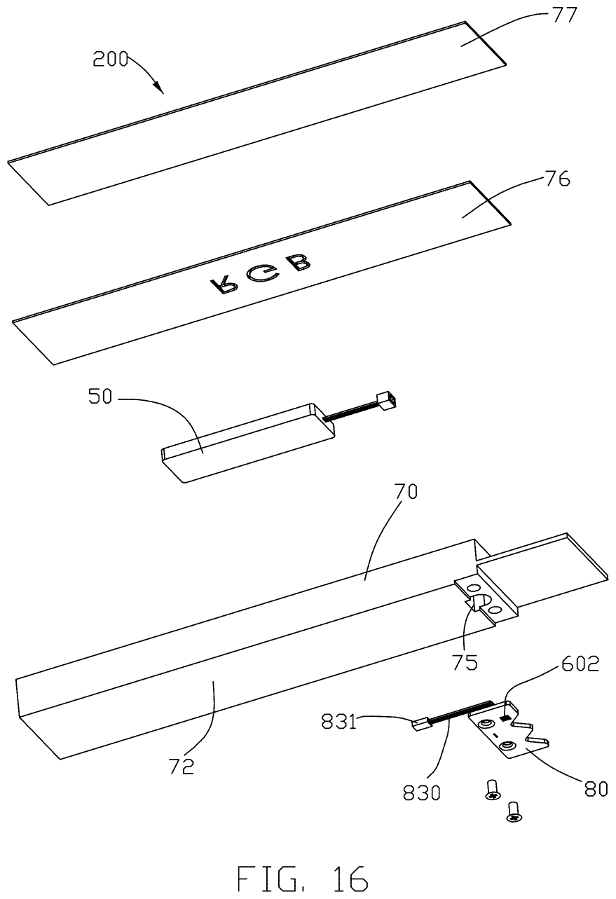

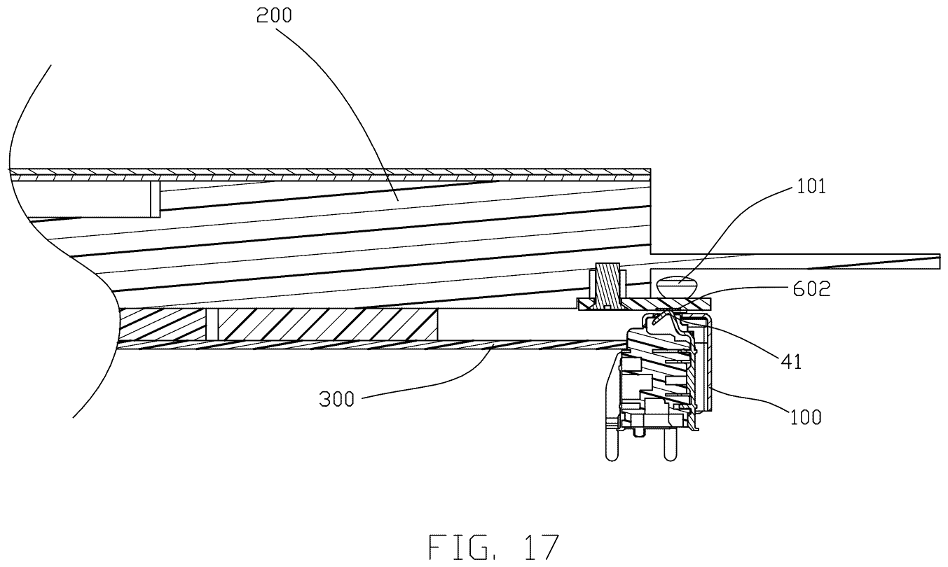

FIGS. 1 to 10 illustrate an electrical connector 100, and a card module 300 and a heat dissipation module 200 which two can be assembled with the electrical connector 100, of a first embodiment of the present disclosure. FIG. 11 to FIG. 18 show a second embodiment, a difference between the first embodiment and the second embodiment is the structure of the heat dissipation module 200.

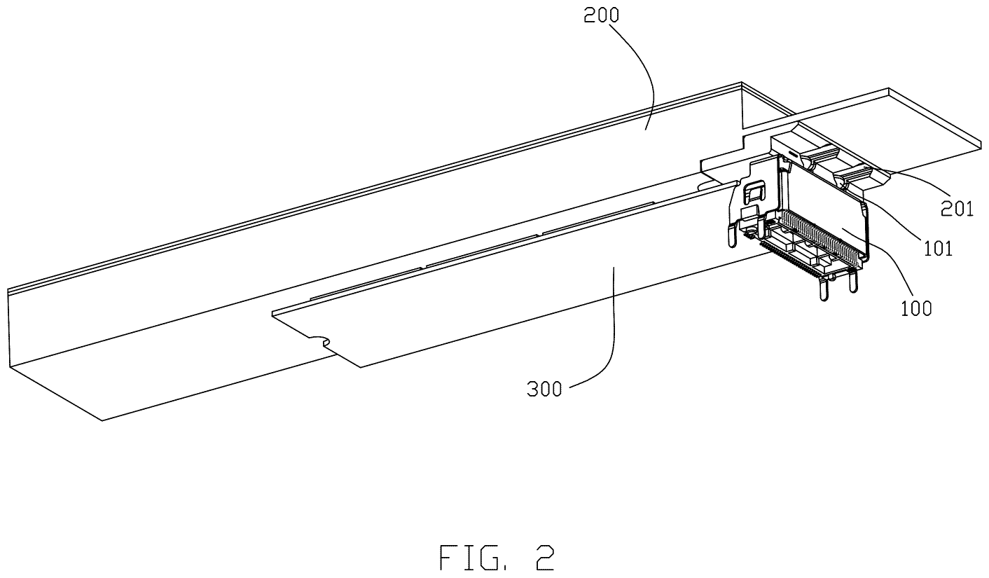

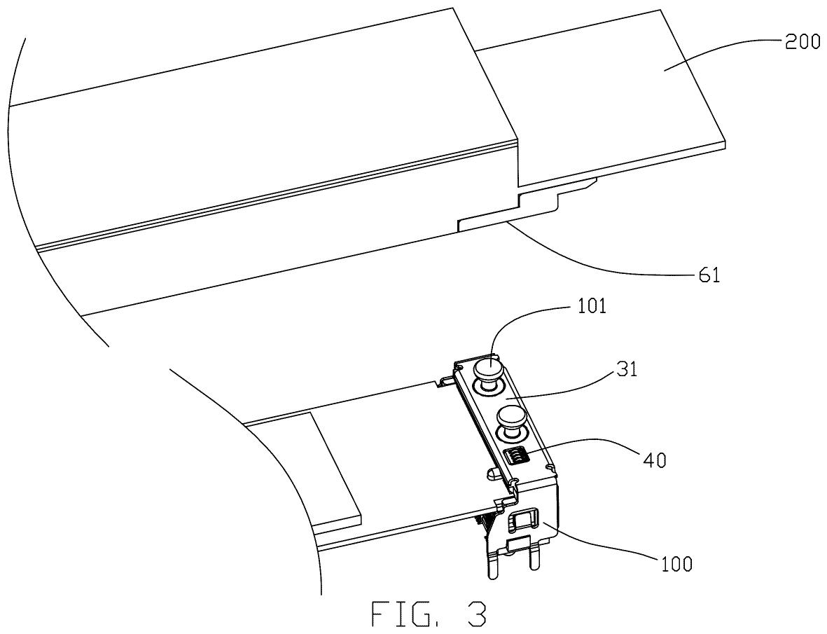

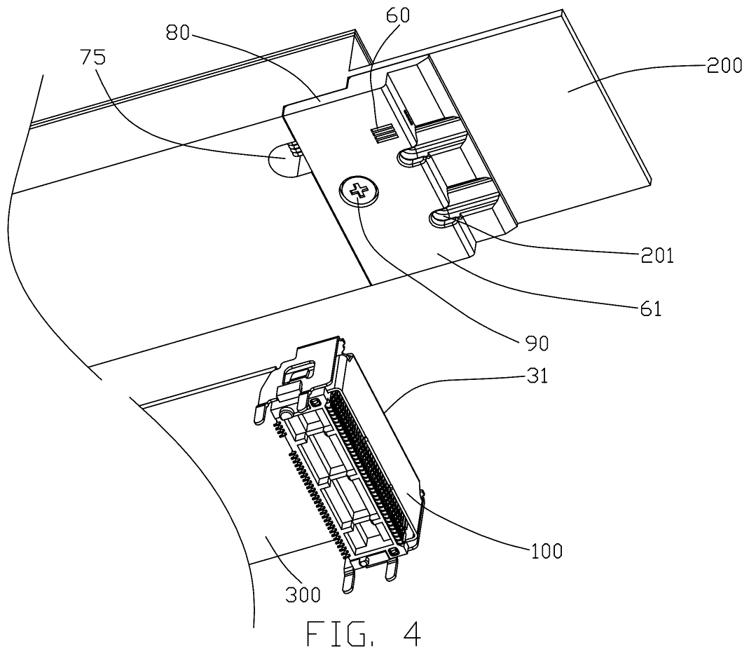

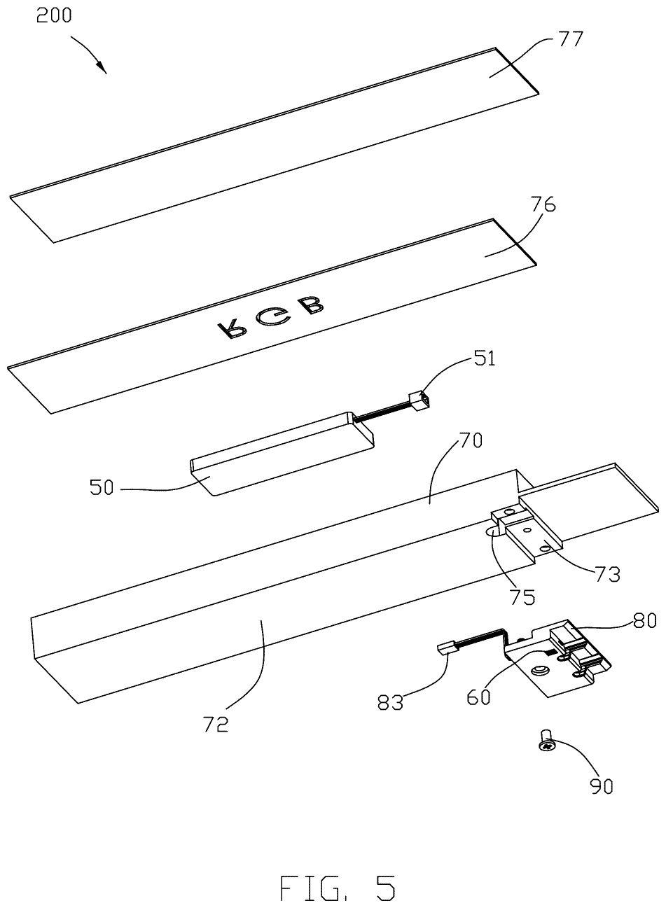

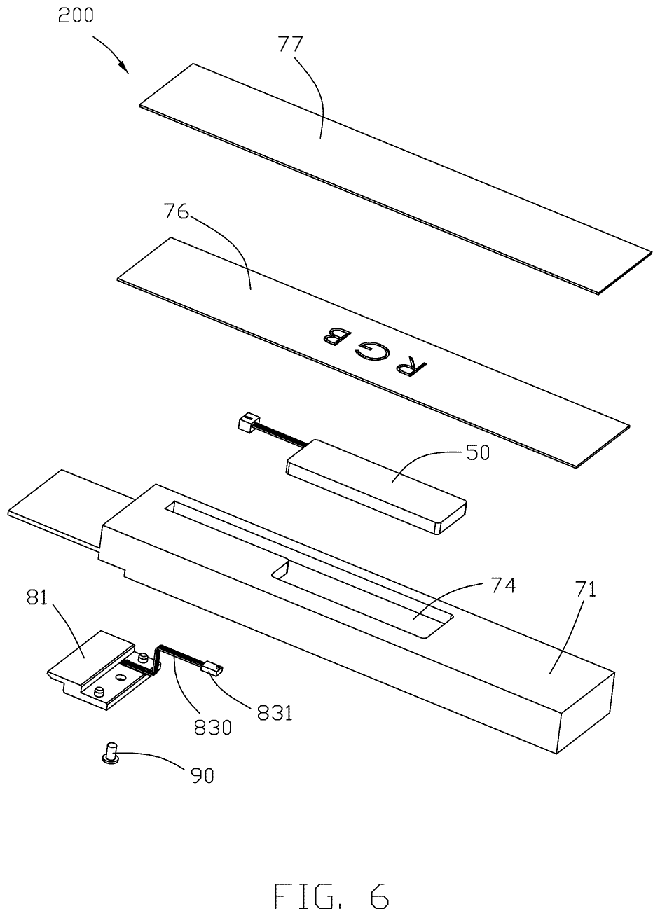

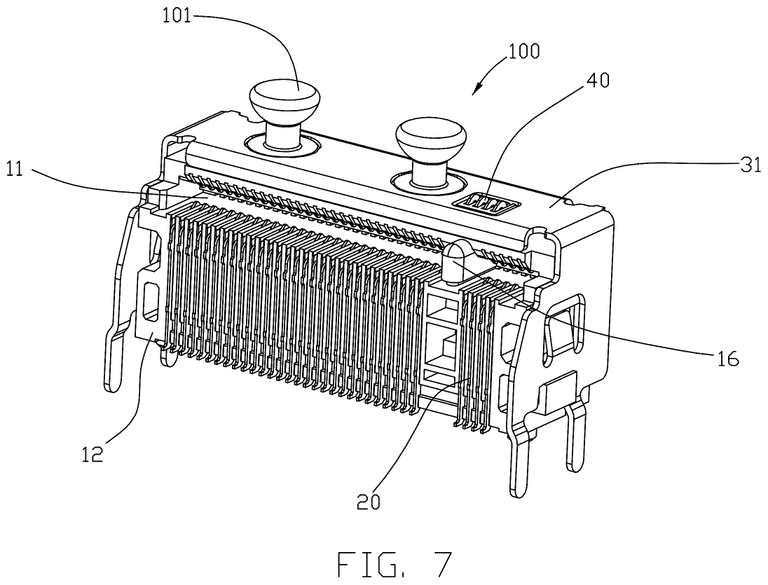

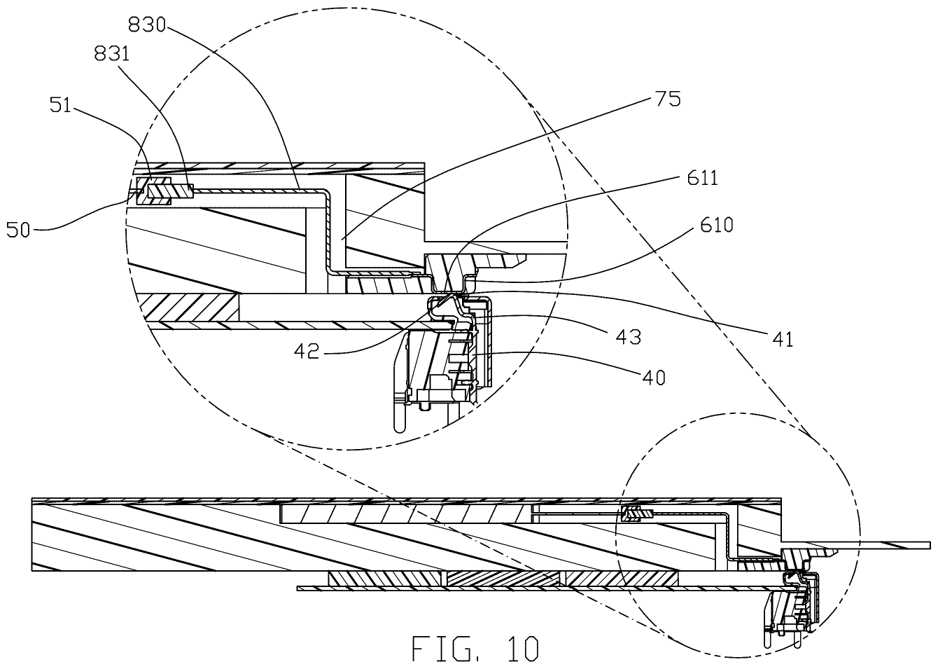

Referring to FIG. 7 to FIG. 9, the electrical connector 100 includes an insulating housing 10, a plurality of terminals 20 fixed to the insulating housing 10, and a metal shell 30 surrounding the insulating housing 10. The insulating housing 10 is formed with a card slot 11. The terminals 20 extend into the card slot 11. Referring to FIG. 1, FIG. 2 and FIG. 10, a card module 300 can be inserted into the card slot 11 for connecting to the plurality of terminals 20 to establish an electric path, and the heat dissipation module 200 and the card module 300 are in contact for achieving a heat dissipation effect. As shown in FIG. 3 to FIG. 4, the electrical connector 100 has a support face 31 arranged above the card slot 11. An end or mating end of the heat dissipation module 200 is assembled to and sits on the support face 31 of the electrical connector 100. The electrical connector 100 has at least one additional terminal 40 exposed at the support face 31. Referring to FIG. 5 and FIG. 6, the heat dissipation module 200 includes an additional-function module 50, and an interface port 60 electrically connected to the additional-function module 50. When the mating end of the heat dissipation module 200 is disposed on the support face 31, the interface port 60 and the additional terminals 40 are in contact, thereby kicking off a working circuit of the additional-function module 50. In the present embodiment, the additional-function module 50 is an LED module, including LED lights which can emit a combination of red, green, and blue light, not only allowing the user to check quickly through lighting if the heat dissipation module 200 and the electrical connector 100 are securely assembled, but also allows a visual effect of the heat dissipation module 200 to be more pronounced. In other embodiments, the type of the additional-function module 50 can be arranged according to specific needs of the user.

Referring to FIG. 7 to FIG. 9, the insulating housing 10 has a front face 12 and a rear face 13 opposite each other, and a top face 14 and a bottom face 15 positioned between the front face 12 and the rear face 13. The card slot 11 passes through the front face 12. The top face 14 includes a protrusion portion 141 having additional-terminal slots 140. In this embodiment, four additional terminals 40 are disposed on the protrusion portion 141 to define an additional port. The additional terminals 40 each include an additional contacting portion 41 located at the additional-terminal slots 140. The metal shell 30 includes a top plate 310 attached to the top face 14 of the insulating housing 10. The support face 31 is formed on the top plate 310. The top plate 310 is formed with an opening 311 aligned to the protrusion portion 141, such that the additional contacting portions 41 are exposed at the support face 31. The plurality of terminals 20 includes top-row terminals and bottom-row terminals respectively positioned at a top side and a bottom side of the card slot 11. The insulating housing 10 includes a key 16 arranged at a front end of the card slot 11. Referring to FIG. 3, the key 16 is configured to couple to a notch (not labeled in the figures) of the card module 300, to prevent misalignment thereof. The key 16 partitions the card slot 11 into two portions. The key 16 is provided no terminals thereon. The additional terminals 40 are arranged at the insulating housing 10, just behind the key 16, thereby fully utilizing the available space of the electrical connector, facilitating the miniaturization of the electrical connector.

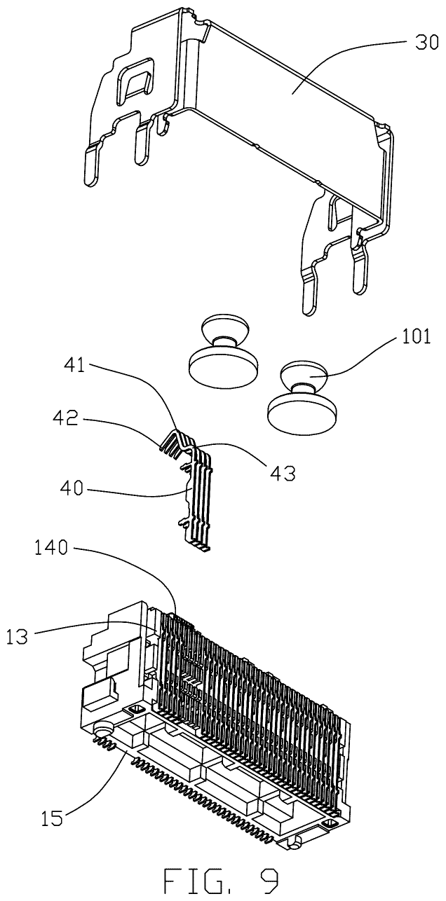

Referring to FIG. 9 and FIG. 10, starting from one end of the at least one additional terminal 40, the additional terminal 40 extends upwards, bends and extends towards the front face 12 to form a bending portion 43, bends and extends upwards until protruding out of the support face 31, bends downward to form the additional contacting portion 41, and extends below the support face 31 such that a free end 42 of the additional terminal 40 is below the support face 31. A side of the additional contacting portion 41 distal from the front face 12 slopes down at a steeper angle than a side of the additional contacting portion 41 proximal to the front face 12. When the additional contacting portion 41 is contacted, the bending portion 43 can bend and the additional terminal 40 can be pushed downward. Specifically, when the side of the additional contacting portion 41 proximal to the front face 12 is contacted, the additional contacting portion 41 can slide downward, and the additional terminal 40 is pushed downward.

As shown in FIG. 3 to FIG. 4, the heat dissipation module 200 has an abutting face 61 for sitting on the support face 31. The interface port 60 is exposed at the abutting face 61. The electrical connector 100 includes a fixing member 101 extending out of the support face 31. The abutting face 61 has a corresponding notch 201. The fixing member 101 engages the notch 201 so as to assemble the heat dissipation module 200 to the electrical connector 100. In the first embodiment, the fixing member 101 is shaped to be half a sphere, and the notch 201 is configured to hug the shape of the fixing member 101. As shown in FIG. 4 to FIG. 6, the heat dissipation module 200 includes a heat dissipation board 70 and a connection module 80. The heat dissipation board 70 has a top surface 71 and a bottom surface 72 opposite each other. One end of the bottom surface 72 is formed with a stage portion 73 which is recessed upward. The connection module 80 can be assembled to the stage portion 73 through a screw 90 (referring to FIG. 4). The top surface 71 is formed with an installation slot 74. The additional-function module 50 is accommodated in the installation slot 74. The connection module 80 includes a main body 81, the interface port 60 attached to the main body 81, and a cable unit 83 connected to the interface port 60. Referring to FIG. 10, the heat dissipation board 70 is formed with a connection slot 75 which is in fluid communication with the stage portion 73 and the installation slot 74. The cable unit 83 passes through the connection slot 75, enters the installation slot 74, and connects to the additional-function module 50. The cable unit 83 and the interface port 60 can be connected through surface mounting technology or through-hole mounting technology. In the first embodiment, the cable unit 83 and the interface port 60 are connected through surface mounting technology. Specifically, the cable unit 83 includes a cable 830 and a cable connector 831. The interface port 60 is an interface terminal 601 injected into the main body 81. The interface terminal 601 includes an interface contacting portion 602 exposed at the abutting face 61, for connecting to the additional contacting portion 41. One end of the cable 830 is connected to the interface terminal 601 through surface mounting technology, and another end of the cable 830 is connected to the cable connector 831. The cable connector 831 is in conduction with a connector 51 arranged on the additional-function module 50. Referring to FIG. 5 and FIG. 6, the heat dissipation module 200 includes a nameplate 76 and a cover 77 covering the top surface 71.

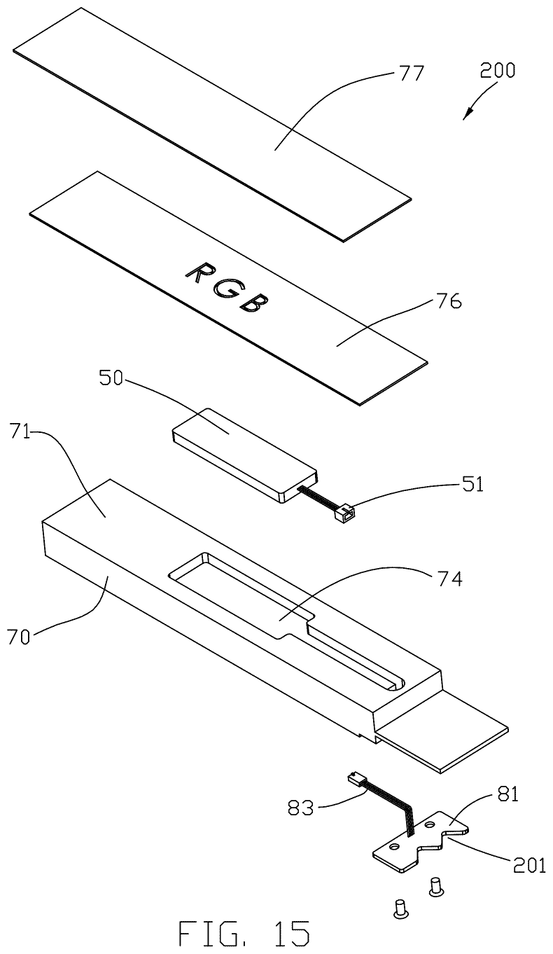

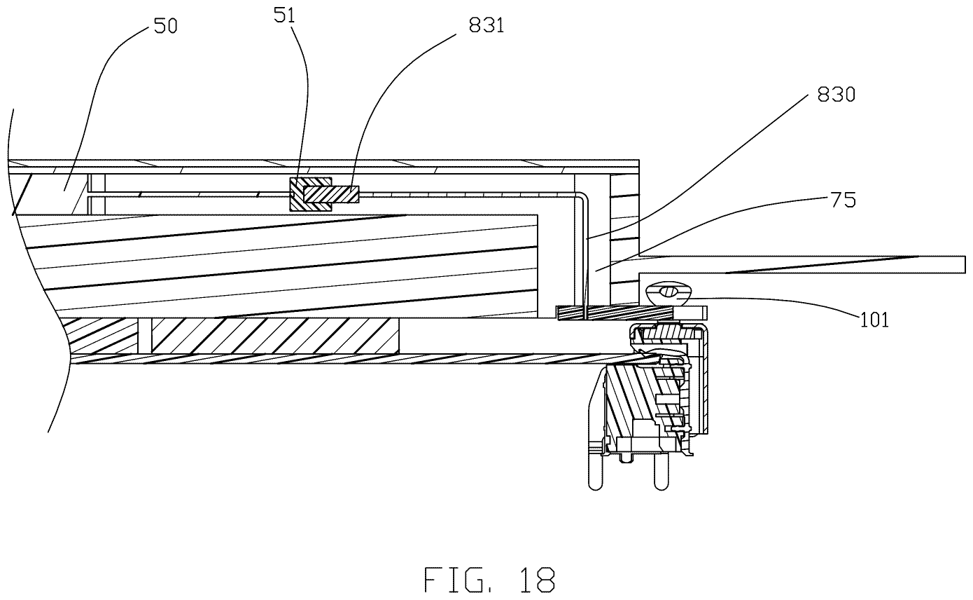

FIG. 11 to FIG. 18 show a second embodiment of the present disclosure. A difference between the second embodiment and the first embodiment is the structure of the heat dissipation module 200. Specifically, the structure of the connection module 80 is slightly different, and the connection method between the cable unit 83 and the interface port 60 is different. Therefore, other similar structures are not further described herein. Referring to FIG. 15 to FIG. 18, the connection module 80 of the heat dissipation module 200 is formed with a notch 201 for engaging the fixing member 101 of the electrical connector 100. The notch 201 is held at a location of connection between the fixing member 101 and the support face 31. Further, the cable unit 83 and the interface port 60 are connected through through-hole mounting technology. The interface port 60 includes a interface contacting portion 602 in conduction with the additional contacting portion 41 and arranged at the abutting face 61, and a connection portion (not shown in the figures) embedded in the main body 81. As shown in FIG. 18, a cable 830 of the cable unit 83 is connected to the connection portion through through-hole mounting technology.

The above-mentioned embodiments are only preferred embodiments of the present disclosure, and should not limit the scope of the present disclosure, any simple equivalent changes and modifications made according to the claims of the present disclosure and the contents of the description should still belong to the present disclosure.

1. An electrical connector assembly comprising:
an electrical connector comprising:
an insulating housing having a card slot;
a support face positioned above the card slot;
a plurality of terminals fixed to the insulating housing and extending into the card slot;
at least one additional terminal exposed at the support face; and
a heat dissipation module comprising:
an additional-function module; and
an interface port electrically connected to the additional-function module; wherein
the interface port contacts the at least one additional terminal to kick off a working circuit of the additional-function module when one end of the heat dissipation module is disposed on the support face.

2. The electrical connector assembly according to claim 1, wherein the heat dissipation module comprises a heat dissipation board and a connection module, the heat dissipation board comprises a top surface and a bottom surface opposite each other, one end of the bottom surface has a stage portion recessed upward, the connection module is assembled at the stage portion, the top surface has an installation slot recessed downward, and the additional-function module is accommodated in the installation slot.

3. The electrical connector assembly according to claim 2, wherein the connection module comprises a main body, the interface port fixed at the main body, and a cable unit connected to the interface port, the heat dissipation board has a connection slot in fluid communication with the stage portion and the installation slot, and the cable unit passes through the connection slot, enters the installation slot, and is connected to the additional-function module.

4. The electric connector assembly according to claim 3, wherein the cable unit and the interface port are connected through a surface mounting technology or a through-hole mounting technology.

5. The electrical connector assembly according to claim 2, wherein the heat dissipation module comprises a nameplate and a cover covering the top surface of the heat dissipation board.

6. The electrical connector assembly according to claim 1, wherein the heat dissipation module comprises an abutting face arranged at the support face, the interface port is exposed at the abutting face, the electrical connector comprises a fixing member protruding from the support face, the abutting face has a corresponding notch engaging the fixing member to assemble the heat dissipation module to the electrical connector.

7. The electrical connector assembly according to claim 1, wherein the additional-function module is an LED module, and the LED module comprises an LED light for emitting a combination of red, green, and blue lights.

8. An electrical connector adapted for being inserted with a card module and being assembled with a heat dissipation module, the electrical connector comprising:
an insulating housing having a card slot;
a support face positioned above the card slot;
a plurality of terminals extending into the card slot; and
at least one additional terminal; wherein
the at least one additional terminal is exposed at the support face and is configured to electrically connect with an additional-function module on the heat dissipation module when the heat dissipation module is disposed on the support face.

9. The electrical connector according to claim 8, further comprising a protrusion portion formed on the insulating housing and a metal shell surrounding the insulating housing, and wherein:
the insulating housing has a front face and a rear face opposite each other and a top face and a bottom face positioned between the front face and the rear face, the card slot passing through the front face;
the protrusion portion is formed on the top face and has an additional-terminal slot;
the at least one additional terminal comprises an additional contacting portion arranged at the additional-terminal slot; and
the metal shell comprises a top plate covering the top face of the insulating housing, the support face is formed at the top plate, and the top plate has an opening corresponding to the protrusion portion and the additional contacting portion is exposed at the support face.

10. The electrical connector according to claim 9, wherein the insulating housing comprises a key in front of the card slot and the at least one additional terminal is located behind the key.

11. The electrical connector according to claim 9, wherein the additional contacting portion is a portion bent downward of the additional terminal.

12. The electrical connector according to claim 8, wherein the at least one additional terminal comprises an additional contacting portion protruding out of the support face.

13. The electrical connector according to claim 12, wherein starting from one end of the at least one additional terminal, the additional terminal extends upwards, bends and extends towards the front face, bends and extends upwards until protruding out of the support face, bends downward to form the additional contacting portion, and extends below the support face.

14. The electrical connector according to claim 12, wherein a side of the additional contacting portion distal from the front face slopes down at a steeper angle than a side of the additional contacting portion proximal to the front face.

15. A heat dissipation module for dissipating heat from a card module and for mating with an electrical connector, the heat dissipation module comprising:
a heat dissipation board having an installation slot;
an additional-function module arranged in the installation slot; and
a connection module having a main body, an interface port, and a cable unit; wherein
the main body of the connection module is attached to one end of the heat dissipation board and has an abutting face facing away from the heat dissipation board, the interface port is embedded in the main body and partially exposed at the abutting face of the main body, and the cable unit of the connection module is connected to the interface port and the additional-function module.

16. The heat dissipation module according to claim 15, wherein the main body of the connection module is formed with a notch for engaging a fixing member of the electrical connector.

17. The heat dissipation module according to claim 15, wherein the interface port comprises an interface-contacting portion exposed at and substantially coplanar with the abutting face of the main body.

18. The heat dissipation module according to claim 15, wherein the heat dissipation board has a top surface and an opposite bottom surface configured to contact and dissipate heat from the card module.

19. The heat dissipation module according to claim 18, further comprising a nameplate and a cover covering the top surface.

20. The heat dissipation module according to claim 15, wherein the additional-function module is an LED module, and the LED module comprises an LED light.
